(19) United States
(12) Patent Application Publication
(10) Pub. No.: US 2026/0194123 A1
(43) Pub. Date: Jul. 9, 2026

(54) FLEXIBLE-SUPPORTED WORM-AND-GEAR MECHANISM

(71) Applicant: Jinan Hanjiang Optoelectronic Technology Co., Ltd, Jinan (CN)

(72) Inventors: Keliang LIAO, Jinan (CN); Maohua SONG, Jinan (CN)

(21) Appl. No.: 19/131,848

(22) PCT Filed: Aug. 15, 2023
(86) PCT No.: PCT/CN2023/113122

§ 371 Date: May 21, 2025

(30) Foreign Application Priority Data
Mar. 30, 2023 (CN) 202310324586.6

(51) Int. Cl. F16H 1/16; F16H 57/021; F16H 57/022; F16H 57/028; F16H 57/12

(52) U.S. Cl. CPC F16H 1/16; F16H 57/022; F16H 57/028; F16H 57/12; F16H 2057/0213; F16H 2057/0225; F16H 2057/0228

(57) ABSTRACT

A worm-and-gear mechanism comprises a worm-and-gear mechanism housing, a worm gear, a nut, an adjusting mechanism, an elastic mechanism, a worm assembly, a fixing plate, a wave bead jacking column, a stabilizing screw, a positioning screw, and a shaft sleeve, wherein the worm assembly comprises a mounting base, a worm sleeve, a nut, a worm bearing, and a worm. The present invention has the advantages that the worm sleeve is adjusted by means of the adjusting mechanism and the elastic mechanism to enable the engagement center distance between the worm and the worm gear to float slightly within the range of D±Δδ, where D is the center distance, and Δδ is a machining error of the worm gear and the worm; it can be ensured that the worm gear and the worm continuously maintains line contact on an engagement surface.

### TECHNICAL FIELD

The present invention relates to the field of mechanical transmission technologies, and in particular, to a flexibly-supported worm-and-gear mechanism.

### BACKGROUND

With the development of industrial automation, a mechanism which can realize 90-degree output during transmission and has a small occupied space and a high efficiency is not common, and worm-and-gear fitting transmission is a transmission mode with a quite wide application range. The worm-and-gear transmission mode is adopted in most of existing rotary table products. However, in the prior art, since a worm gear is an integral gear structure, and during transmission, a backlash exists during tooth surface contact between the worm gear and a worm, a high precision requirement exists during machining of the worm gear and the worm, and if the manufacturing precision is not high, the positioning precision of the worm gear and the worm during fitting is difficult to guarantee, and thus, the precision of a workpiece product produced by a rotary table is easily influenced, and meanwhile, large noise is generated. In the actual use process, the worm gear and the worm are rigidly connected after mounted and fitted, and the worm gear and the worm are abraded after long time worm-and-gear transmission, thus influencing the use precision and engagement precision; in existing worm-and-gear fitting, once assembling is finished and engagement is successful, the worm gear can only rotate unidirectionally due to self locking of the worm gear and the worm, and during power-off debugging, the worm gear cannot be adjusted to an accurate required position through manual adjustment. Most of existing worm-and-gear backlash adjusting mechanisms are used for motor reducers, automobile steering or robot steering, and less applied to the field of rotary tables.

In Chinese Patent CN211778893U, a multi-spring-supported and single-spring-tensioned structure (as shown in FIG. 1) is proposed in an automatic anti-backlash worm-and-gear reducer, but the structure has the problems that mounting is inconvenient, an elastic force range is fixed after spring mounting, active adjustment cannot be realized, pressure-bearing wearing of the worm gear and the worm is aggravated, and after excessive wearing, further engagement cannot be realized, and a worm-and-gear mechanism cannot be actively, conveniently and fast separated from an engagement state.

In a robot worm-and-gear floating anti-backlash transmission mechanism in Chinese Patent CN209228983U, a worm floating assembly and an elastic element are adopted to achieve the purpose of adjusting the center distance of the worm gear and the worm to engage the worm gear and the worm (as shown in FIG. 2), but the mechanism has the problems that the mechanism size is large, the floating assembly is rigid, the adjustment precision of an outer sliding rail is not high, the mechanism cannot be placed in some experimental scenarios with small size requirements, the adjustment speed is excessively low, the process is complex, and a transmission backlash caused by later wearing between the worm gear and the worm cannot be automatically adjusted.

In other patents (e.g., CN114475771A and CN102421654B), only a single direction force (i.e., a force pushing the worm towards the worm gear) is provided, thus resulting in excessively tight engagement of the worm and the worm gear, increasing wearing between the worm and the worm gear, and shortening the service life of the worm-and-gear mechanism.

### SUMMARY

### Technical Problem

An object of the present invention is to solve the above problems that engagement assembly of the worm gear and the worm is difficult, the rotation precision of the worm gear and the worm during rigid engagement working cannot be ensured, the rotation angle of a table surface of the worm gear cannot be quickly adjusted due to self locking after engagement assembly of the worm gear and the worm, the backlash fitting precision is not high, the machining cost is excessively high, rigid engagement causes large noise, and the service life is not long.

### Technical solution

The present invention has the following technical solution.

A flexibly-supported worm-and-gear mechanism includes a worm-and-gear mechanism housing, a worm gear, an adjusting mechanism, an elastic mechanism, a worm assembly, a fixing plate, a wave bead jacking column, a stabilizing screw, a positioning screw, and a shaft sleeve, wherein the worm assembly includes a mounting base, a worm sleeve, a nut, a worm bearing, and a worm, the fixing plate is mounted on the worm-and-gear mechanism housing through a bolt, the wave bead jacking column is mounted on a reserved hole site of the fixing plate, the worm assembly is inserted into a reserved hole site of the fixing plate, a position of the worm assembly is fixed by the adjusting mechanism, the stabilizing screw, the positioning screw, and the shaft sleeve through hole sites reserved in the worm-and-gear mechanism housing, and the worm gear is mounted on a mounting position reserved on the worm-and-gear mechanism housing; the wave bead jacking column provides a first direction force which enables the worm assembly to be inclined away from the worm gear with the positioning screw as a fulcrum, the adjusting mechanism and the elastic mechanism together provide a second direction force for pressing the worm sleeve of the worm assembly to cause the worm assembly to get close to the worm gear, and the first direction force and the second direction force are opposite in direction and in a balanced state by adjusting the adjusting mechanism and the elastic mechanism, so as to guarantee engagement of the worm gear and the worm.

The first direction force and the second direction force can be adjusted by adjusting the wave bead jacking column, the adjusting mechanism, and the elastic mechanism.

The worm-and-gear mechanism housing is provided with the position for mounting the worm gear and the position for mounting the worm assembly, and the hole sites for the adjusting mechanism, the fixing plate, the stabilizing screw, and the positioning screw are reserved in the worm-and-gear mechanism housing; at the position for mounting the worm assembly, a mounting hole is expanded at a rear end region of the position, namely a rear end of the insertion position when the worm assembly is mounted, so as to ensure that the worm assembly has a certain left-right transverse displacement; the worm-and-gear mechanism housing has a cambered section at a contact position of the worm gear and the worm, and a size of the cambered section is customized according to sizes of the worm gear and the worm; and the mounting hole sites for the fixing plate, the adjusting mechanism, the stabilizing screw, and the positioning screw are reserved in the worm-and-gear mechanism housing.

Further, the nuts are mounted on two sides of the worm bearings after the worm bearings are mounted on the worm gear, and configured to fix positions of the worm bearings.

Further, a hole site for mounting and using the elastic mechanism is reserved in a center of the adjusting mechanism, the adjusting mechanism is a stepped pin, the hole site is a through hole in the center of the pin, and a diameter of the hole is customized according to the elastic mechanism.

Further, the elastic mechanism has various forms, such as an elastic mechanism jointly formed by a screw, a spring, and a jacking bead or an elastic mechanism formed by a wave bead screw; after the elastic mechanism is mounted at the hole site in the adjusting mechanism, the second direction force applied by the elastic mechanism to the worm sleeve is adjusted after mounting of the adjusting mechanism is complete.

Further, a hole site for connection with the mounting base, a hole site for fixing a jackscrew, and a hole site for mounting the shaft sleeve are reserved in the worm sleeve; the hole site for mounting the shaft sleeve is cut to be level, so as to mount and use the positioning screw; meanwhile, a hole site for engagement of the worm gear and the worm is reserved in an engagement position of the worm gear and the worm, the worm sleeve has a cambered section at the contact position of the worm gear and the worm, and a size of the cambered section is customized according to the sizes of the worm gear and the worm. A center position of the worm sleeve is fixed through the positioning screw, and the worm sleeve drives the worm mounted therein to move in a certain range through a force generated by abutting of the wave bead jacking column and the mounting base, so as to ensure that a center distance of the worm gear and the worm is within a center-distance standard range of a corresponding model, and the wave bead jacking column can be adjusted according to floating of the center distance caused by abrasion between the worm gear and the worm, so as to adjust the center distance of the worm gear and the worm by adjusting the worm sleeve and the worm mounted therein.

Further, the worm bearing is an angular contact bearing or a deep groove ball bearing, and the bearings are mounted at two ends of the worm, so as to guarantee normal movement of the worm, and share a pressure on the worm when the worm sleeve is adjusted by the adjusting mechanism.

Further, the worm is a multi-step worm, such that a weight of the worm can be reduced while the position of the bearing is guaranteed to be stable.

Further, the hole site for mounting the wave bead jacking column and a hole site for threaded connection and mounting to the worm-and-gear mechanism housing are reserved in the fixing plate, and the hole site for inserting and mounting the worm assembly into the worm-and-gear mechanism housing is reserved in a center of the fixing plate.

Further, a top end of the wave bead jacking column is spherical, the jacking column has a thread, a mounting length of the wave bead jacking column on the fixing plate is determined by performing a calculation according to specific models of the worm gear and the worm, the wave bead jacking column is mounted after the fixing plate is mounted on the worm-and-gear mechanism housing, and at this point, the wave bead jacking column applies the first direction force to the mounting base to cause the mounting base and the worm sleeve fixed to the mounting base to be inclined away from the worm gear by a certain angle.

Further, a hole site for connection with the worm sleeve is reserved in the mounting base, the mounting base is customized according to a size of a motor, and a hole site for mounting the motor is formed in the mounting base.

Further, the stabilizing screw penetrates through the hole site reserved in the worm-and-gear mechanism housing and tightly presses the worm sleeve after the adjusting mechanism and the elastic mechanism are adjusted.

Further, the positioning screw penetrates through the hole site reserved in the worm-and-gear mechanism housing and the shaft sleeve mounted on the worm sleeve to tightly press the worm sleeve; the positioning screw has the function of ensuring that a position of a top end of the worm sleeve is not changed.

Further, the shaft sleeve is mounted in the hole site reserved in the worm sleeve and configured to fix positions of the worm sleeve and the positioning screw, so as to reduce a loss degree of the positioning screw.

Further, the positioning screw and the shaft sleeve are combined to be used as the fulcrum of the worm sleeve for the first direction force and the second direction force, such that the first direction force and the second direction force can be guaranteed to stably realize a dynamic balance, and the first direction force and the second direction force can be adjusted to support the engagement of the worm and the worm gear after the worm gear and the worm are worn in a later period, thus prolonging the service life of the mechanism.

### Beneficial Effects

The present invention has the following beneficial effects:
(1) in the present invention, worm-sleeve flexible supporting is adopted, and the first direction force provided by the wave bead jacking column and the second direction force provided by combining the adjusting mechanism and the elastic mechanism can be adjusted to be in the balanced state under the condition of ensuring the engagement of the worm gear and the worm, such that the engagement center distance between the worm and the worm gear slightly floats within the range of D±Δδ, wherein D is the center distance, and Δδ is a machining error of the worm gear and the worm, and therefore, it is ensured that the worm gear and the worm continuously maintains line contact on an engagement surface, and thus, the rotation accuracy of the worm gear and the worm is ensured, and the flexible worm sleeve effectively protects the worm from being damaged when the adjusting mechanism is adjusted many times;
(2) in the present invention, worm-sleeve flexible supporting is adopted, the worm gear and the worm can be quickly separated from the engagement state by adjusting the elastic mechanism without disassembling a shell assembly, stopping a machine and damaging the motor and the worm, rotation of the worm gear is stopped, and then, the rotation of the worm gear can be manually and quickly adjusted in a non-engagement state, and inconvenient adjustment caused by self locking of the worm gear and the wear is avoided;
(3) in the present invention, worm-sleeve flexible supporting is adopted, and higher assembly precision and use precision can be obtained through the mechanism according to the present invention under the condition of low precision of the worm gear and the worm. Therefore, the manufacturing costs of the worm gear and the worm are reduced;
(4) in the present invention, the structure is simple, assembling is convenient and fast, parts are convenient to replace, and meanwhile, the stable center distance of the worm gear and the worm is guaranteed, and the use precision is guaranteed;
(5) the elastic mechanism in the present invention has various types, adapts to different solutions and is practical.

### BRIEF DESCRIPTION OF THE DRAWINGS

FIG. 1 is a prior art.

FIG. 2 is a prior art.

FIG. 3 is a schematic structural diagram of a flexibly-supported worm-and-gear mechanism.

FIG. 4 is a bottom view of the flexibly-supported worm-and-gear mechanism.

FIG. 5 is a sectional view taken along line B in FIG. 4.

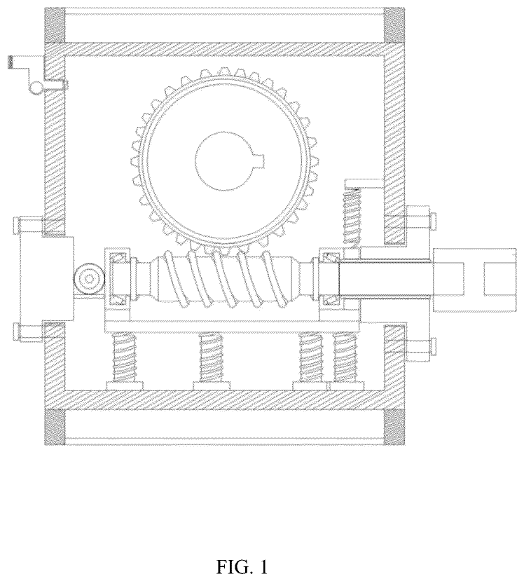

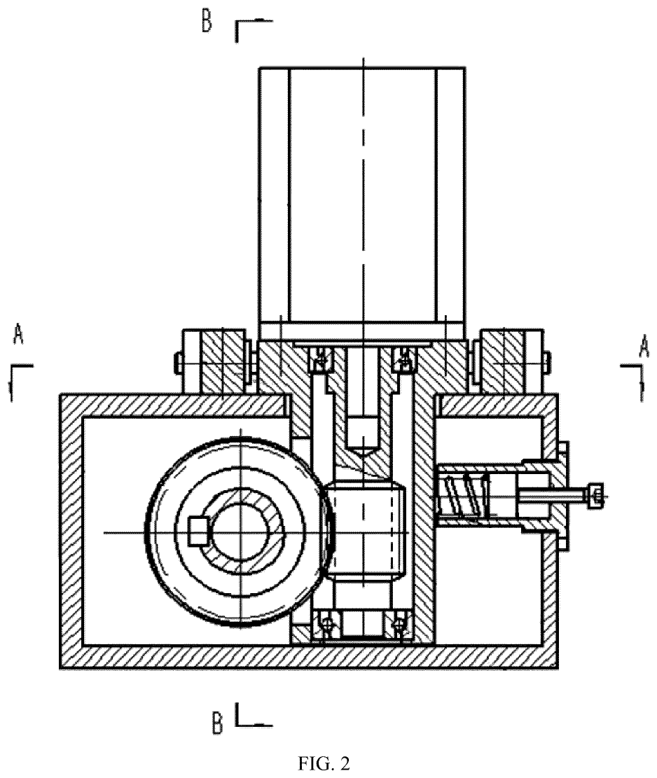

Reference numerals: 1—worm-and-gear mechanism housing, 2—worm gear, 3—nut, 4—adjusting mechanism, 5—elastic mechanism, 6—worm sleeve, 7—worm, 8—worm bearing, 9—fixing plate, 10—wave bead jacking column, 11—mounting base, 12—stabilizing screw, 13—positioning screw, 14—shaft sleeve, 101—second direction force, 102—pushing force, and 103—first direction force.

### DETAILED DESCRIPTION OF THE EMBODIMENTS

In order to make the objects, technical solutions and advantages of the embodiments of the technical solution of the present invention more apparent, the present invention is further described below with reference to the accompanying drawings and the embodiments.

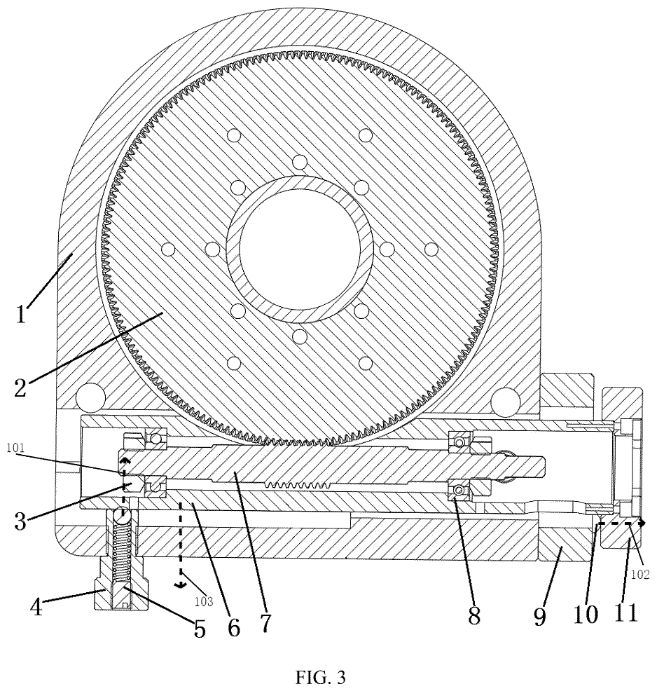

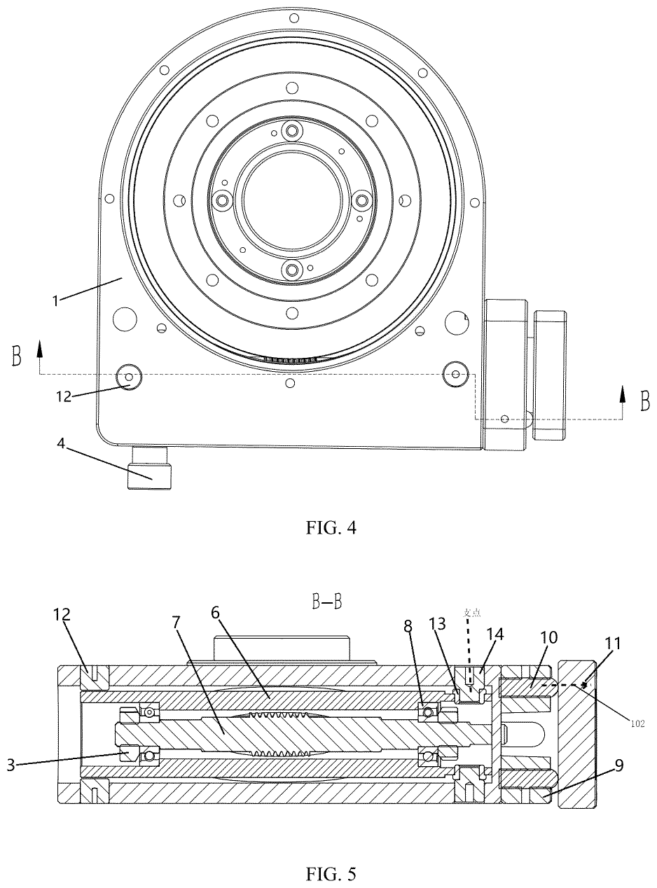

As shown in FIG. 3, FIG. 4 and FIG. 5, the present invention includes a worm-and-gear mechanism housing 1, a worm gear 2, a nut 3, an adjusting mechanism 4, an elastic mechanism 5, a worm sleeve 6, a worm 7, a worm bearing 8, a fixing plate 9, a wave bead jacking column 10, a mounting base 11, a stabilizing screw 12, a positioning screw 13, and a shaft sleeve 14. A material of the elastic mechanism 5 has various choices. An RS20 worm-and-gear assembly is exemplified below, and the present invention is not limited thereto; the center distance thereof floats; that is, the range of D±Δδ is 80±0.05 mm, and the floating range of the center distances of worm-and-gear assemblies with different models is determined according to actual requirements.

In a first embodiment, the elastic mechanism 5 is jointly formed by a screw, a spring, and a jacking bead. An assembling process thereof includes: mounting the worm 7 in the worm sleeve 6, fixing a position of the worm 7 by means of two worm bearings 8 and two nuts 3, and mounting the mounting base 11 and the worm sleeve 6 together. After the worm gear 2 is mounted at a corresponding position of the worm-and-gear mechanism housing 1, the fixing plate 9 is mounted on the worm-and-gear mechanism housing 1 and fixed by a bolt, and then, the wave bead jacking column 10 with a calculated proper length is mounted in a reserved hole site of the fixing plate 9. An assembly consisting of the worm 7, the worm sleeve 6, the mounting base 11, the worm bearing 8, and the nut 3 is mounted at a corresponding position of the worm-and-gear mechanism housing 1, and a position of the worm 7 is adjusted to cause the worm to be engaged with the worm gear 2 by erecting the worm-and-gear mechanism housing 1. After the worm gear 2 is engaged with the worm 7, two stabilizing screws 12 and two positioning screws 13 penetrate through hole sites reserved in the worm-and-gear mechanism housing 1 to tightly press the worm sleeve 6, such that a position of the worm sleeve 6 is fixed; in order to prevent the positioning screw 13 from being abraded, the shaft sleeve 14 for protecting the positioning screw 13 is mounted in advance at a mounting position of the positioning screw. Then, the adjusting mechanism 4 is mounted in a hole site reserved in the worm-and-gear mechanism housing 1, and is screwed tightly to stabilize the position of the worm sleeve 6, and meanwhile, the corresponding position of the worm sleeve 6 is convenient to adjust. Finally, the worm-and-gear mechanism housing 1 is laid flat, and the position of the worm sleeve 6 is determined by adjusting the tightness degree of the elastic mechanism 5. In the using process of the flexibly-supported worm-and-gear mechanism, the positioning screw 13 is used as a displacement supporting point of the worm sleeve 6 while stabilizing the position of the worm sleeve 6, the wave bead jacking column 10 provides a certain pushing force 102 for the mounting base 11 to incline the mounting base 11, and meanwhile, the worm sleeve 6 mounted on the mounting base 11 also moves by a corresponding angle therewith, and a certain gap is reserved in a region of the stabilizing screw 12 where the worm sleeve 6 is located in the worm-and-gear mechanism housing 1 for the worm sleeve 6 to move. Since the worm sleeve 6 is in a normal usable state under the combined action of the adjusting mechanism 4 and the elastic mechanism 5, when the elastic mechanism 5 is adjusted to be loose, the worm sleeve 6 is inclined by a certain angle, the worm and the worm gear 2 are not engaged at this point, and the worm gear 2 can rotate freely, such that a position can be adjusted quickly. Similarly, when the elastic mechanism 5 is tightened, the worm 7 can be better engaged with the worm gear, thus improving the engagement precision, reducing a gap between the worm gear 2 and the worm 7, reducing noise, and prolonging the service life; directions of the pushing force, a second direction force and a first direction force are different.

In a second embodiment, the elastic mechanism 5 is a wave bead screw or another part with the same structure but a different name, such as a jacking wave bead screw or a wave screw. Other usage modes are the same as in the first embodiment.

With reference to the above embodiments and the accompanying drawings, in the present application, a coupler with a corresponding model and a motor with a corresponding model are mounted at an end of the worm 7 close to the fixing plate 9, and then, after preparation is completed using the above mounting and debugging method, the wave bead jacking column 10 is adjusted to press the mounting base 11 (i.e., the direction of the pushing force 102), the worm sleeve 6 is moved away from the worm gear 2 with the positioning screw 13 as a fulcrum (i.e., the direction of the first direction force 103), and then, by screwing and pressing of the adjusting mechanism 4 and the elastic mechanism 5, the worm sleeve 6 is forced to the worm gear 2 (i.e., the direction of the second direction force 101), and meanwhile, the worm 7 in the worm sleeve 6 thus also moves towards the worm gear 2, the two worm bearings 8 mounted in the worm sleeve 6 share a pressure, and the elastic mechanism 5 can also ensure that the worm gear and the worm are tightly engaged; if the screwing degree is excessively large, the worm-and-gear mechanism can also be ensured to perform automatic adaptation due to elasticity, and when the center distance is enlarged when the worm gear and the worm are worn in long-time running, automatic pressing and engagement can be realized due to the elastic mechanism 5, thus ensuring that the debugging process is simple and convenient; in the present application, the adjusting mechanism can also be screwed out without stopping a machine and damaging the motor and the worm 7 in the running process of the mechanism, the worm gear and the worm can be separated from the engagement state, rapid braking is realized, and a position of a turntable driven by the worm gear 2, namely the position of the worm gear 2 can be manually and rapidly adjusted.

The above-described embodiments are merely preferred embodiments of the present invention, and do not limit the structure and scope of the present invention. Indeed, some equivalent variations may be made according to the shapes, structures and design objectives described in the present invention. Therefore, all the equivalent variations made according to the shapes, structures and design objectives described in the present invention should be covered by the protection scope of the present invention; that is, these equivalent variations should be protected by the present invention.

1. A flexibly-supported worm-and-gear mechanism, comprising a worm-and-gear mechanism housing, a worm gear, an adjusting mechanism, an elastic mechanism, a worm assembly, a fixing plate, a wave bead jacking column, a stabilizing screw, a positioning screw, and a shaft sleeve, wherein the worm assembly comprises a mounting base, a worm sleeve, a nut, a worm bearing, and a worm, the mounting base is mounted on an outer side of one end of the worm sleeve, and the nut, the worm bearing, and the worm are mounted in the worm sleeve; the fixing plate is mounted on the worm-and-gear mechanism housing through a bolt; the wave bead jacking column is mounted on a reserved hole site of the fixing plate; the worm assembly is inserted into a reserved hole site of the fixing plate as a whole, and a position of the worm assembly is fixed by the adjusting mechanism, the stabilizing screw, the positioning screw, and the shaft sleeve through hole sites reserved in the worm-and-gear mechanism housing; the worm gear is mounted on a mounting position reserved on the worm-and-gear mechanism housing; the wave bead jacking column provides a pushing force for the mounting base to incline the mounting base, such that the worm assembly can obtain a first direction force for inclining the worm assembly away from the worm gear with the positioning screw as a fulcrum; the adjusting mechanism is mounted on the worm-and-gear mechanism housing, the elastic mechanism is mounted in a hole site reserved in the adjusting mechanism, and after the adjusting mechanism and the elastic mechanism are mounted, the elastic mechanism is adjusted to press the worm sleeve of the worm assembly, so as to cause the worm assembly to get close to the worm gear and provide a second direction force; directions of the pushing force, the second direction force, and the first direction force are different, the second direction force is opposite to the first direction force, and the second direction force and the first direction force are in a balanced state by adjusting the adjusting mechanism and the elastic mechanism, the balanced state being intended to ensure that a center distance between the wear gear and the worm is within a center-distance standard range.

2. The flexibly-supported worm-and-gear mechanism according to claim 1, wherein the worm-and-gear mechanism housing is provided with the position for mounting the worm gear and the position for mounting the worm assembly, and the hole sites for the adjusting mechanism, the fixing plate, the stabilizing screw, and the positioning screw are reserved in the worm-and-gear mechanism housing; at the position for mounting the worm assembly, a mounting hole is expanded at a rear end region of the position; the worm-and-gear mechanism housing has a cambered section at a contact position of the worm gear and the worm, and a size of the cambered section is customized according to sizes of the worm gear and the worm; and the mounting hole sites for the fixing plate, the adjusting mechanism, the stabilizing screw, and the positioning screw are reserved in the worm-and-gear mechanism housing.

3. The flexibly-supported worm-and-gear mechanism according to claim 1, wherein a hole site for mounting and using the elastic mechanism is reserved in a center of the adjusting mechanism.

4. The flexibly-supported worm-and-gear mechanism according to claim 1, wherein the elastic mechanism is an elastic mechanism jointly formed by a screw, a spring, and a jacking bead or an elastic mechanism formed by a wave bead screw; after the elastic mechanism is mounted at the hole site in the adjusting mechanism, the elastic mechanism is adjusted to tightly press the worm sleeve after mounting of the adjusting mechanism is complete.

5. The flexibly-supported worm-and-gear mechanism according to claim 1, wherein a hole site for connection with the mounting base, a hole site for fixing a jackscrew, and a hole site for mounting the shaft sleeve are reserved in the worm sleeve; the hole site for mounting the shaft sleeve is cut to be level, so as to mount and use the positioning screw; meanwhile, a hole site for engagement of the worm gear and the worm is reserved in an engagement position of the worm gear and the worm.

6. The flexibly-supported worm-and-gear mechanism according to claim 1, wherein the worm bearing is an angular contact bearing or a deep groove ball bearing.

7. The flexibly-supported worm-and-gear mechanism according to claim 1, wherein the hole site for mounting the wave bead jacking column and a hole site for threaded connection and mounting to the worm-and-gear mechanism housing are reserved in the fixing plate, and the hole site for inserting and mounting the worm assembly into the worm-and-gear mechanism housing is reserved in a center of the fixing plate.

8. The flexibly-supported worm-and-gear mechanism according to claim 1, wherein a top end of the wave bead jacking column is spherical, the jacking column has a thread, and a mounting length of the wave bead jacking column on the fixing plate is determined by performing a calculation according to specific models of the worm gear and the worm.

9. The flexibly-supported worm-and-gear mechanism according to claim 1, wherein the worm is a multi-step worm.

10. The flexibly-supported worm-and-gear mechanism according to claim 1, wherein the positioning screw penetrates through the hole site reserved in the worm-and-gear mechanism housing and the shaft sleeve mounted on the worm sleeve to tightly press the worm sleeve.
